(19) United States
(12) Patent Application Publication
(10) Pub. No.: US 2003/0235268 A1
(43) Pub. Date: Dec. 25, 2003

(54) Pinhole tomographer

(76) Inventor: Roberto Vallarta Mendoza, Citrus Heights, CA (US)

Correspondence Address: Roberto Vallarta Mendoza, 6355 Cheltenham Way, Citrus Heights, CA, 95621, US

(21) Appl. No.: 10/175,688

(22) Filed: Jun. 19, 2002

(51) Int. Cl. G21K 1/12

(52) U.S. Cl. 378/21

(57) ABSTRACT

A pinhole box with a pinhole (12), and enclosing walls (15) constructed in such manner that the walls will prevent waves used in application from penetrating the interior of the box, said walls also constructed such that the inner surface of the walls will absorb said waves used during application, and a detector (16) to detect and record the intensity of said waves across the surface of the detector, thus recording the real image produced inside the pinhole box, the type of detector used dependent upon the type of wave used during application, said detector must be able to detect presence of and variations in the intensity of said waves across the surface of the detector.

### BACKGROUND

1. Field of Invention

This invention relates to various forms of remote sensing, specifically, with the various methods of tomography. Some examples of such tomography are, but not limited to, Computerized Assisted Tomography, sonography, Positron Emission Tomography, Synthetic Aperture Tomography, etc.

2. Description of Prior Art

The camera obscura has been well known for centuries. There are two basic types of camera obscura: the pinhole type and the lens.

The pinhole type, henceforth called a pinhole box, is basically a chamber, box, or any closed enclosure where the only opening is the pinhole. The inside walls of the enclosed opening is usually painted black except for the side opposite the pinhole. Light enters the pinhole and projects images of the outside onto the side opposite the pinhole. The black walls will absorb any stray light, thus preventing it from obscuring the integrity of the image on the wall.

The lens camera obscura, henceforth called a lens type, uses a much wider opening than a pinhole with a lens placed in the opening.

In the camera obscura, the light entering either the pinhole or the lens projects what is called a real image inside the chamber. The real image is not seen by the naked eye until some sort of surface cuts across it. Then, the image will be seen as a projection on the surface.

In the pinhole box, the real image can be anywhere between the pinhole and the opposite side. Thus if one places a surface in the path of the light entering the pinhole, a projection of the image will always be seen. In the lens type, the location of the image depends on the distance of the object being imaged and the focal length of the lens. The further the object, the closer the image of the object is to the focal point of the lens. Thus, if one wants to project the image onto a surface, the surface must be moved either closer to or further away from the focal point. This technique is otherwise known in common parlance as focusing.

In the nineteenth century, the use of photographic emulsions enabled the permanent recording of the real images and the camera obscura became the camera. Photography, the first true type of remote sensing, was invented. The pinhole box became the pinhole camera and the lens type became the lens type camera. In the new technique, the use of the lens type was far more popular than the use of the pinhole box, and almost all cameras in use today is of the lens type. Part of the unpopularity of the pinhole box is that the sharpness of the photographs depends on the smallness of the pinhole. However, reducing the size of the pinhole lengthens the exposure time needed to capture an image on the film. As a matter of fact, capturing a nighttime image with a pinhole camera is almost impossible.

It is probably because of the popularity of the lens type camera that when another type of image recording was discovered, the pinhole box was totally ignored. X-rays are used to record images. Since x-rays don't normally refract or reflect, the use of a lens to make an x-ray camera is impractical. X-ray images taken today are actually shadow images, that is the film records the x-ray shadow cast by the object being imaged.

Since then, other types of remote sensing have been discovered. Some examples are radar, which uses reflected radio waves to locate objects. Sonar uses reflected sound waves to locate objects underwater. The use of computers has resulted in various methods of tomography. Whether one uses sound waves, radio waves, positrons, etc., all methods of tomography uses the computer to process multiple readings taken at multiple locations to develop an image. Most of these forms of remote sensing are used in situations were the object under consideration cannot be detected by the naked eye. Almost always, the objects being studied are inside some other objects or surface. Thus, pipes are usually located inside or behind walls or under the ground. Medical diagnostics require the ability to study objects or organs inside the human body. These are just some examples. In all these cases, the use of waves which can penetrate the obscuring object to reach the object to be studied is required. Thus the use of sound waves, radio waves, etc.

The Pinhole Tomographer proposed here goes back to the principle of the pinhole camera. The difference is that the pinhole tomographer uses waves other than that of visible light. Note that according to physics, particles are also waves, i.e., the Pinhole Tomographer can also be configured to use electrons, positrons, and other types of particles.

The Pinhole Tomographer is meant to address the shortcomings of the other forms of remote sensing which uses waves other than non-visible light. In most cases, these waves do not easily reflect or refract, thus making it hard to use lenses or reflectors to form images. Where it is possible to form an image, the image formed is usually too small relative to the transducers meant to detect them or, because of their relatively long wavelengths, the image is of too poor a quality to be of any use. Thus:

(a) In the use of these waves, the location of the object being studied can be located in spatial space but no image can be formed.

(b) Using the known forms of tomography to form images require the detector to be positioned in hundreds if not thousands of different locations around the object to be studied. This is not only time-consuming and cumbersome, the equipment and electronics needed to effect such an operation is expensive.

(c) The exception are cases like x-ray photography where a shadow image can be formed. However, the quality of these images are poor. Thus, computerized assisted tomography (CAT) is usually needed if one really wishes to see fine details in the image.

(d) The time-consuming nature of most forms of tomography means that the objects being imaged cannot be seen in real time, that is, one cannot see what is happening to the objects while it is happening. The image must first be processed and only later seen.

(e) The expensesiveness of the equipment, the time-consuming nature of their use, and the cumbersomeness of their use means that it is almost impossible for the average person to use most forms of tomography.

### OBJECTS AND ADVANTAGES

Accordingly, the Pinhole Tomographer will have the following advantage over the usual forms of tomography. Some of the advantages are:

(a) The Pinhole Tomographer will, like the pinhole box, produce a real image. This real image will be not he made up of visible light but of the type of waves used in the operation.

(b) The real image can be detected in various ways and can provide images in real time.

(c) The Pinhole Tomographer simply being a camera with the construction adjusted to use waves other than that of visible light, it is as basically as easy as easy to use as a camera.

(d) The simplicity of construction means that it will not be as expensive as other forms of tomography.

(e) Fast and easy use means that it can be used extensively in applications. There is no time consuming preparation needed just to set it up for use.

### DRAWING FIGURES

In the drawings, FIGS. 3 to 8 are meant to show variations on the method of detecting and recording waves.

FIG. 1 shows a side view of the pinhole box with a surface, to detect and record waves, opposite the pinhole.

FIG. 2 shows an exploded view of the device with a surface, to detect and record waves, opposite the pinhole.

FIG. 3 shows a pinhole box with a film to detect and record the intensity of waves.

FIGS. 4A and 4B shows various aspects of the transducer array with the individual transducer elements, 4A is a side view, 4B is a front view.

FIGS. 5A and 5B shows various aspects of a transducer element for detecting and recording waves, 5A being a side view, 5B being a front view.

FIG. 6 shows a pinhole box with a curved transducer array opposite the pinhole.

FIG. 7 shows the curved transducer array with the various transducer elements.

FIG. 8 shows a pinhole box with a single movable transducer element.

### REFERENCE NUMERALS IN DRAWINGS

12 pinhole opening in box

16 detector

18 transducer array

22 transducer

28 LED or light bulb

15 pinhole box walls

17 film

19 transducer circuit

25 electric circuit

34 electric motor

### Summary

In accordance with the present invention, a pinhole box constructed so as to, using waves other than visible light, the enclosing walls prevent said waves from penetrating to the insides of the box except through the pinhole, and such that the inner surface of the box will absorb said waves. At the back of and inside the pinhole box, facing the pinhole, a film, transducer array, or whatever is appropriate to detect and record the intensity of such waves.

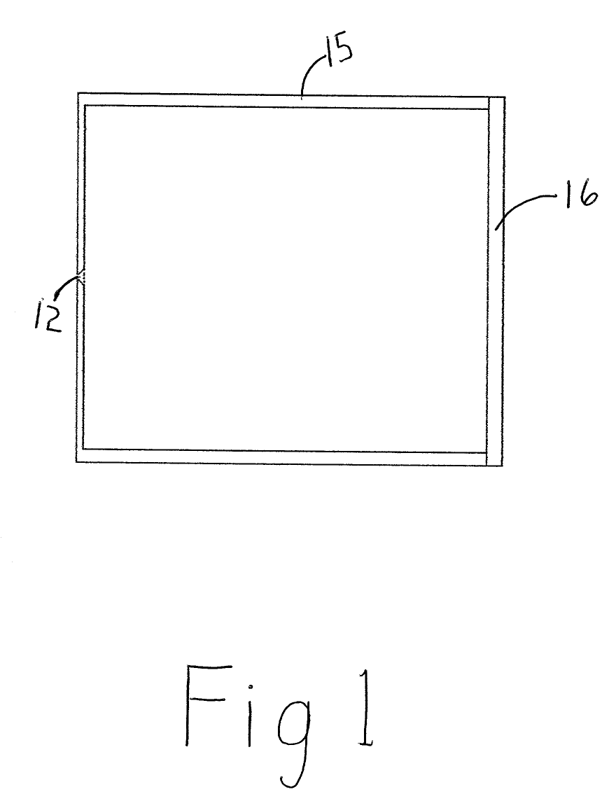

### Description—FIGS. 1 to 8

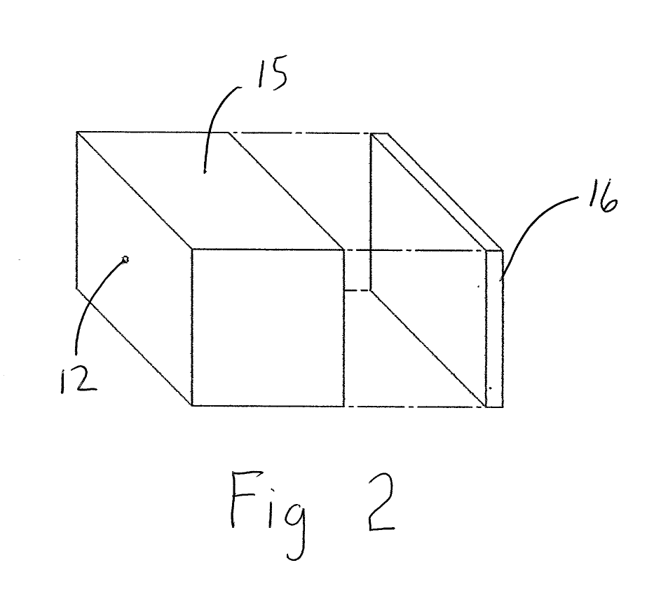

A typical embodiment of the invention is shown in FIGS. 1 to 2. As in an ordinary pinhole camera, the invention consists of a box with one of the sides of the box containing a pinhole 12. The invention diverges from the pinhole camera in that the detector 16 used need not necessarily be a photographic film. The type of detector will depend on the type of wave used during application and will consist of a detector that can actually record said waves. Thus, a photographic film might be used to detect x-rays, an antenna array can be used to detect radio waves, a microphone can be used to detect sounds, etc. The invention also diverges from the pinhole camera in that the materials and construction of the walls 15 comprising the box must meet the requirements of the type of wave used in the operation of the invention. If radio waves are used during the operation, the walls must be made of metal the will prevent radio waves from entering the box except through the pinhole. The inside part of the walls must be made as radar-absorbent as much as possible. If sound waves are used the walls must be sound-proof as much as possible and the inside part of the walls must be as sound-absorbent as much as possible. Other types of waves can be used and the construction of the walls must be adjusted accordingly to prevent said waves from entering the pinhole and for the inside part of the wall to absorb those waves.

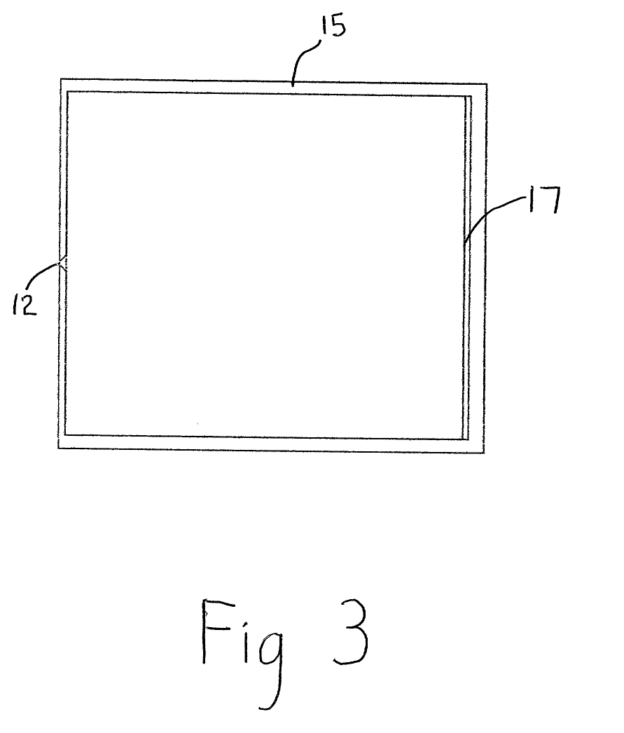

FIG. 3 shows a Pinhole Tomographer that uses a film 17. The construction differs from the pinhole camera only in the materials that comprise the walls of the box are adjusted to prevent whatever wave is used in application from entering the box except through the pinhole, and the inside surface of the box will absorb said waves. As a typical example, if the waves used are X-rays, then the walls might be made of lead.

FIGS. 4A to 4B shows a typical array. Each of the boxes in the array represents an individual transducer 19. FIGS. 4A and 4B does not necessarily represent the exact number of transducers in the array. As a matter of fact, the more individual transducers per surface area in the array, the sharper the final image that will be produced by the invention. The transducer array will produce an image because there will be variations in the intensity of the waves reaching each of the individual transducers in the array.

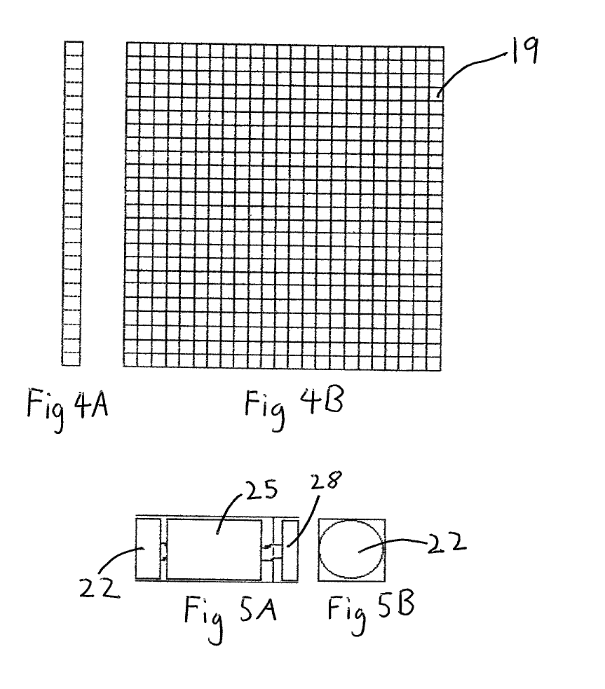

FIGS. 5A and 5B shows various aspects of the individual transducers used in the array. The type of transducer used in the array will depend on the type of wave to be used in the operation. If one were to use radio waves during the operation, the individual transducers will use an antenna, if one uses sound waves during the operation, the transducer will use a microphone, etc. FIGS. 5A to 5B shows a typical transducer circuit. Here, the transducer 22 detects the waves. An electric circuit 25 amplifies the signal from the antenna. An LED 28 or light bulb 28 will give off visible light in response to signals from the electric circuit. The stronger the radio wave detected from the antenna, the more intense the light given off by the LED or light bulb.

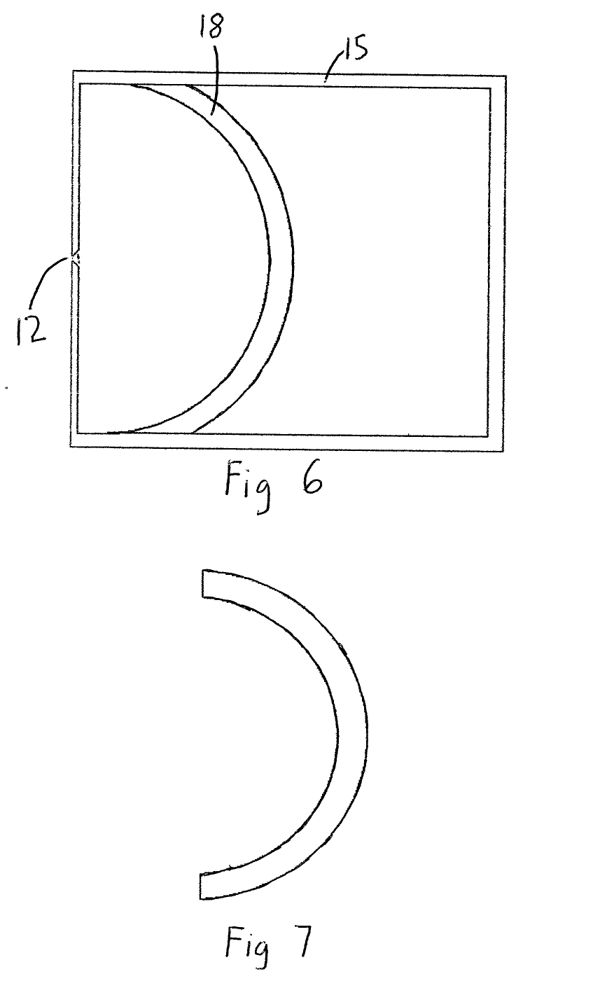

FIGS. 6A, 6B, and 7 show another variation on the method of detecting and recording the intensity of the waves used in application. Here, the transducer array is in the shape of a half-sphere with the pinhole located at what would be the center. The individual transducers 19 are arranged in such a way that the surface of the transducer array is perpendicular to the line of sight enamating from the pinhole.

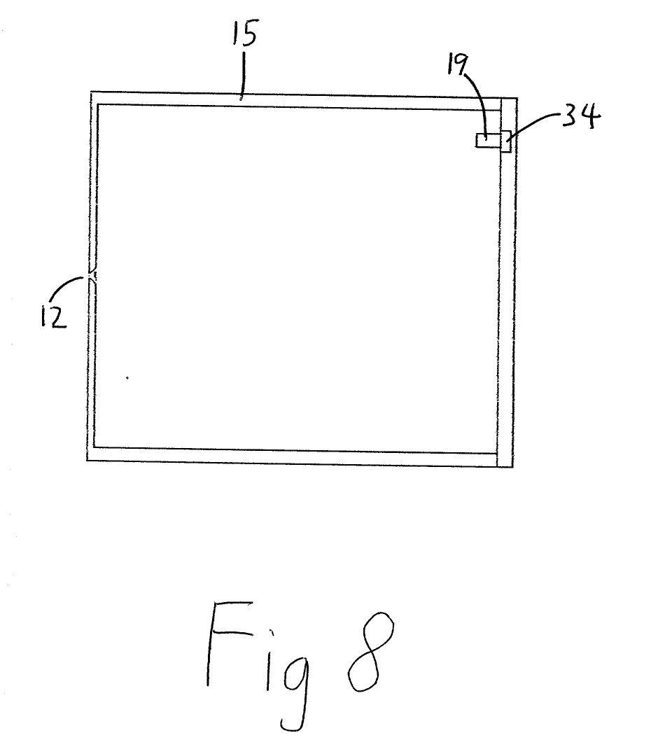

Another variation is shown in FIG. 8. Here, instead of a transducer array, there is a single transducer 19 with a motor 34. The transducer can move across the back inside surface of the pinhole box.

From the descriptions above, the following may be inferred:

(a) The invention is essentially a pinhole camera with the materials for construction altered to detect waves other than that of visible light.

(b) The method of alteration in the construction of this invention will depend on the type of wave used in the operation.

(c) Where the type of waves used during application precludes the use of any type of film, the method of using a transducer array makes it possible to construct an image without the need for computer assisted processing.

(d) If one chooses not to use a transducer array where applicable, it would be possible to construct an image using a single movable transducer, with signals from the movable transducer being processed digitally by a computer.

### Operation—FIGS. 1,4,5,6,7,8

As has been previously stated, this invention works in the same manner as a pinhole camera, the sole difference being the use of waves other than visible light to produce the image and corresponding changes in the construction of the camera to accommodate said changes.

In FIG. 1, the pinhole 12 is initially covered with a material that would reflect whatever type of waves is used in the operation. When the pinhole is uncovered, waves will enter the box through the pinhole. The waves will encounter the detector 16 and the intensity of the waves across the surface of the detector is recorded. If, as in FIG. 3, a film is used, the film can later be developed and the intensity of the waves can be seen.

If the type of waves used in application precludes the use of film, a transducer array as shown in FIG. 4 can be used in place of the film. As individual waves impinge upon individual transducers 19 and FIG. 5 in the transducer array shown in FIG. 4, the LED/light bulbs 28 in each transducer will give off visible light, the intensity of the light varying with the intensity of the individual wave. Referring to FIG. 4, since the intensity of the waves will vary across the surface in accordance with the principle of pinhole images, the variation in intensity of the LED/light bulbs across the back surface of the array will result in a pattern roughly corresponding to the real image produced across the front surface of the array. The degree to which this image corresponds with the real image will depend on the number of transducers per surface area in the array. The greater this number, the closer this correspondence, i.e., the sharper the image.

As long as the pinhole is open, the LEDs/light bulbs in the back of the transducer array will produce an image. This image is an upside-down image of what the naked eye would see, i.e., if the image taken is that of a tree, the image produced in the array will be an upside-down tree.

A flat transducer array is not necessarily the only way to produce an image from the waves entering the pinhole box. As shown in FIG. 6 and 7, a spherical shaped array can also be used. This arrangement is especially useful in cases where the direction of the wave affects the ability of the individual transducer 19 to detect it. For example, if one were to used a ferrite core antenna to detect radio waves, the front surface of the individual transducer needs to be perpendicular to the direction of the wave. Thus, in the spherical arrangement of the transducer array, the wave impinging on the individual transducer will always by perpendicular to the individual transducer since the surface of the transducer array is always perpendicular to the line of sight emanating from the pinhole.

Also, if time is not a constraint, a single individual transducer 19 moving across the entire inside back surface of the pinhole box will be able to obtain an image. This process requires digital processing and an electric motor 34 to move the individual transducer. As the individual transducer moves across the back surface, at each moment in time a computer can record the intensity of the impinging wave and the location of the individual transducer at the time the impinging wave was detected.

### Conclusion, Ramifications, and Scope

Accordingly, the reader will see that the modifications to the basic pinhole camera of this invention can be used to obtain images of objects using waves other than that of visible light. Also unlike previous methods of tomography, this invention will, like a camera, produce a what is referred to in physics as a real image within the box. Although, much of the discussion so far has centered on methods of registering this image, one should not lose sight of the fact that the production of that image is the crux of this invention. Some of the advantages of this inventions are

If one were to, using x-rays as waves, use the Pinhole Tomographer in medical diagnostics, the invention will produce sharper and more detailed images than can be obtained using conventional shadow images typically used in x-ray imaging.

If one were to use it in medical diagnostics, this invention is less expensive to produce and less time-consuming to use.

It permits images to be taken of closed spaces like briefcases, car trunks, etc. If one uses sound waves or radio waves, this method, unlike the use of x-rays, can be done safely. Thus an intensive search can be done without worrying about potential health repercussions.

Since it is more practical to use radio waves as opposed to x-rays when operation out in the field, this method can be used to obtain such images with the same ease, portability, and practicality of using a camera.

This method can, again with the same ease, portability, and practicality of a camera, use sound waves to obtain underwater images. This has potential applications, not only in ocean research, but in search and rescue operations along rivers, ponds, and lakes, especially where the visibility in such bodies of water is much reduced.

This method can, again with the same ease, portability, and practicality of a camera, use either sound waves or radio waves to obtain images of objects underground. This has great utility in such applications as locating and seeing underground pipes, locating and seeing buries archeological objects, locating and seeing underground tunnels and caves, etc.

Since different materials absorb and reflect sound waves or radio waves differently, this method can, again with the same ease, portability, and practicality of a camera, use sound waves or radio waves to locate and see underground features such as veins of ore, or in general, anything buried underground whose composition is different from the surrounding soil or rock.

Using shock waves from man-made explosions or seismic waves from earthquakes, this invention can locate and see images of earthquake faults.

Although the descriptions above contain many specifics, they should not be construed as limiting the scope of the invention but merely provides illustrations of how the use of different form of waves will provide different applications for the invention.

I claim:

1. The use of a pinhole box, to use waves of forms other than visible light to form real images, made up of the waves mentioned, inside the box, the term pinhole box being understood as any enclosed chamber with a single pinhole being the sole open path between the inside of the box and the outside of the box.

2. The adjustment in construction of the pinhole camera to adjust for the fact that waves other that that of visible light will be used to form the real image and obtain a visible image.

3. The construction of the outside of the box to be made of material that will reflect the waves that will be used in application.

4. The construction of the inside part of the box, with the exception of the side opposite the pinhole, to be made of material that will absorb the type of waves that will be used during the operation of the invention.

5. The use of materials to fill the cavity of the box where the permeability of said materials to the waves used in application will be more or less the same as the permeability of the general environment where the pinhole in the box will be placed in contact.

6. The use of transducer arrays to detect the real image within the box.

7. The use of an electric circuit and an LED or light bulb in each transducer where the intensity of the light released by the LED or light bulb varies with the intensity of the wave detected by the transducer.

8. The use of these LEDs or light bulb within the array to approximate the real image within the pinhole box.

9. The construction of a spherical shaped transducer array where a point on the surface of the transducer array is perpendicular to the line of sight from the pinhole to that particular point on the surface.

10. The adaptation of the pinhole box to the use of waves other than visible light for the purpose of obtaining an image the interior of the human body.

11. The adaptation of the pinhole box to the use of waves other than visible light for the purpose of obtaining images from beneath the surface of the ground.

12. The adaptation of the pinhole box to the use of waves other than visible light for the purpose of obtaining images from within enclosed, covered, partly enclosed, or partly covered spaces.

13. The adaptation of the pinhole box to the use of waves other than visible light for the purpose of obtaining images from underneath the surface of bodies of water.

14. The adaptation of the pinhole box to the use of waves other than visible light for the purpose of obtaining images of features and conditions on any kind of surface.

15. The adaptation of the pinhole box to the use of waves other than visible light for the purpose of obtaining atmospheric images.
